(19) United States
(12) Patent Application Publication
(10) Pub. No.: US 2026/0175559 A1
(43) Pub. Date: Jun. 25, 2026

(54) MAT AND METHOD FOR MANUFACTURING THE SAME

(71) Applicant: The Parallax Group International, LLC, Aliso Viejo, CA (US)

(72) Inventors: Bruce A. Thrush, Monarch Beach, CA (US); Tung-An Liu, Changhua County (TW)

(21) Appl. No.: 19/541,174

(22) Filed: Feb. 16, 2026

Related U.S. Application Data
(62) Division of application No. 18/744,620, filed on Jun. 15, 2024, now Pat. No. 12,565,034.
Application No. 18/744,620 is a division of application No. 17/891,806, filed on Aug. 19, 2022, now Pat. No. 12,011,910.

(30) Foreign Application Priority Data
Sep. 16, 2021 (TW) 110134672

(51) Int. Cl. B32B 38/00; B32B 5/20; B32B 5/32; B32B 7/022

(52) U.S. Cl. CPC B32B 38/0004; B32B 5/20; B32B 5/32; B32B 7/022; B32B 2250/03; B32B 2250/22; B32B 2250/242; B32B 2266/0221; B32B 2266/025; B32B 2270/00; B32B 2305/022; B32B 2305/026; B32B 2307/404; B32B 2307/536; B32B 2307/72; B32B 2307/732; B32B 2471/04

(57) ABSTRACT

A mat and a method for manufacturing the same are provided. The mat includes a first foam layer, a second foam layer and a third foam layer. The first foam layer has a first hardness and a first porosity. The second foam layer is connected with the first foam layer and has a second hardness and a second porosity larger than the first porosity. The third foam layer is connected with the second foam layer and has a third hardness and a third porosity smaller than the first porosity. The second foam layer includes a first connecting surface facing the first foam layer and a second connecting surface facing the third foam layer. The contact area between the first connecting surface and the first foam layer is different from the contact area between the second connecting surface and the third foam layer.

This application claims priority to Taiwanese application no. 110134672 filed on Sep. 16, 2021. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is mats and methods for manufacturing the same.

### BACKGROUND

The following description includes information that may be useful in understanding the present invention. It is not an admission that any of the information provided herein is prior art or relevant to the presently claimed invention, or that any publication specifically or implicitly referenced is prior art.

Conventional mats, such as yoga mats, game mats, and anti-slip mats, may be made from different materials and provided with different degrees of foaming for respective functional requirements. To increase a thickness of the mat or meet other requirements, the mat may include layers adhered by an adhesive. For instance, the mat may include a foam layer and an anti-slip layer adhered to a side of the foam layer so that a surface of the mat can provide anti-slip effect.

However, the adhesive may have odor which results in a poor user experience, and the mat often has a complicated manufacturing process that is high cost. In addition, the bonding strength between two adjacent layers may be insufficient due to property differences between the layers and the adhesive, and the hardness, compression rate, and other performance attributes of the mat may be locally influenced due to the adhesive.

The present invention is, therefore, arisen to obviate or at least mitigate the above-mentioned disadvantages. Thus, there is still a need for an improved mat and a method of manufacturing the same.

### SUMMARY OF THE INVENTION

The inventive subject matter provides apparatus, systems and methods in which a—

The main object of the present invention is to provide a mat and a method for manufacturing the same, which is odorless, multifunctional and easy to manufacture.

To achieve the above and other objects, the present invention provides a mat, including: a first foam layer, a second foam layer and a third foam layer. The first foam layer has a first hardness and a first porosity. The second foam layer is connected with a side of the first foam layer and has a second hardness and a second porosity larger than the first porosity. The third foam layer is connected with a side of the second foam layer opposite to the first foam layer and has a third hardness larger than both the first hardness and the second hardness and a third porosity smaller than the first porosity. The second foam layer includes a first connecting surface facing the first foam layer and a second connecting surface facing the third foam layer, and a size of the contact area between the first connecting surface and the first foam layer is different from a size of the contact area between the second connecting surface and the third foam layer.

To achieve the above and other objects, the present invention further provides a method for manufacturing the mat as described above, including following steps of: preparing the first foam layer, the second foam layer, and the third foam layer, respectively, by foaming; connecting the second foam layer with one of the first foam layer and the third foam layer by thermo-compression; connecting the second foam layer with the other of the first foam layer and the third foam layer by thermo-compression to form a substrate; and cutting the substrate to form at least one mat.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of one embodiment of a mat.

FIG. 2 is an exploded view of another embodiment of a mat.

FIG. 3 is an exploded view of another embodiment of a mat.

FIG. 4 is a partial enlargement of another embodiment of a mat.

FIG. 5 is an enlarged view of the mat of FIG. 1.

FIG. 6 is perspective view of several interlocking mats.

FIG. 7 is a flow chart of one embodiment of a method of manufacturing a mat.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

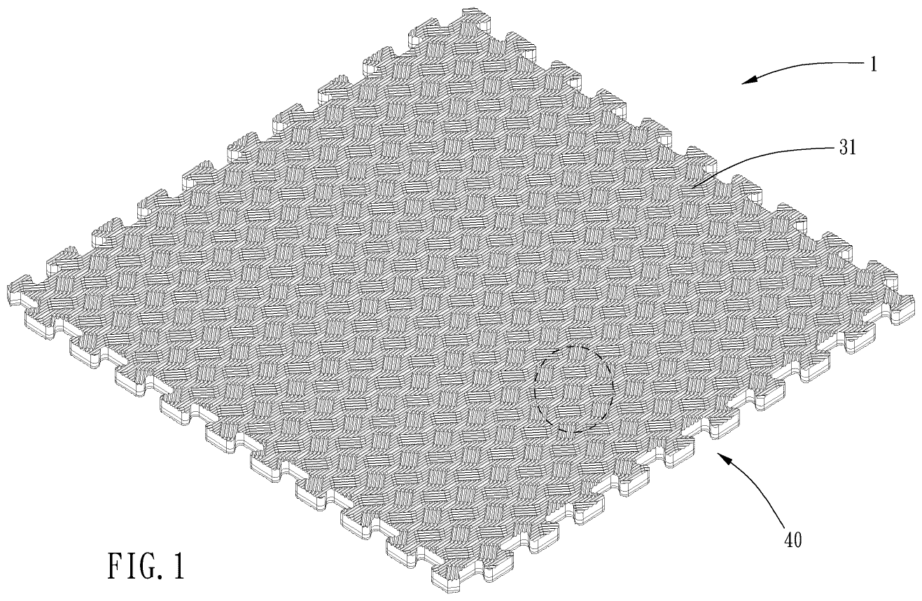

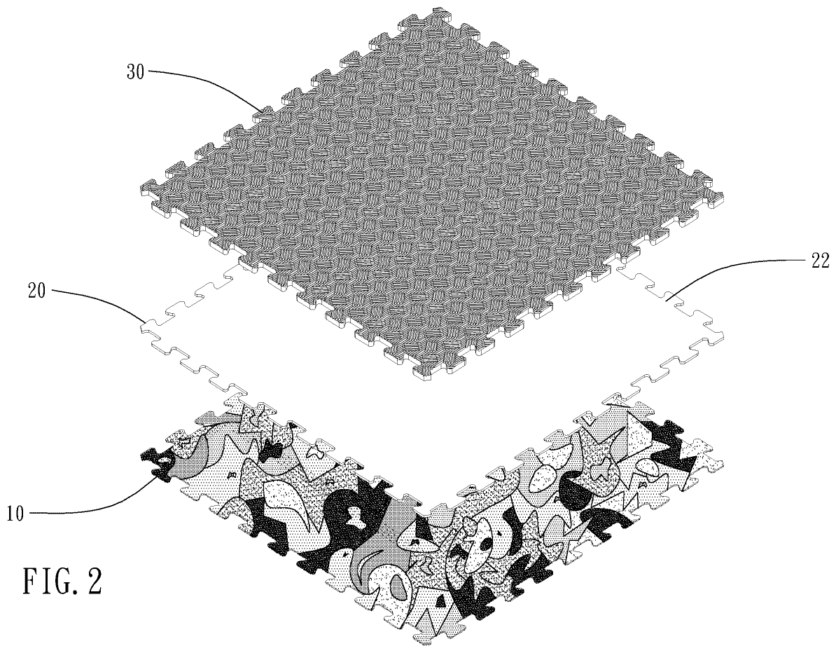

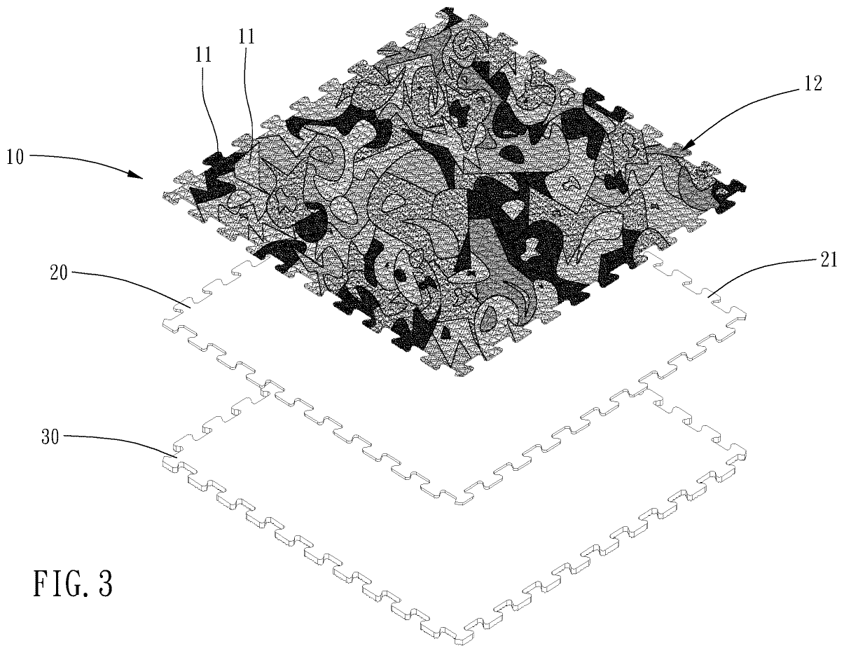

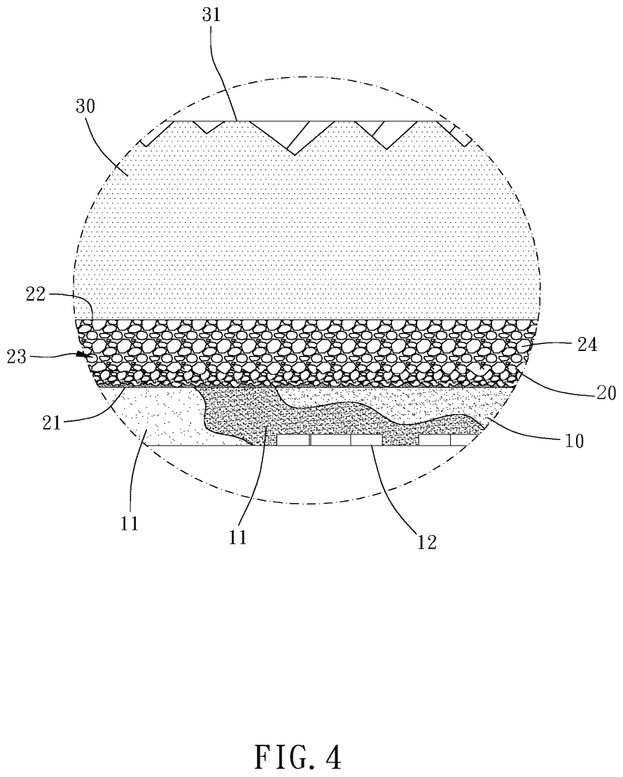

FIG. 1 shows a perspective view of a mat 1 having a contact surface 31 and a structure 40. FIG. 2 shows an exploded top perspective view of mat 1. FIG. 3 shows an exploded bottom perspective view of mat 1. Structure 40 consists of a first foam layer 10, a second foam layer 20 and a third foam layer 30. The second foam layer 20 has a first connecting surface 21 that couples with the first foam layer 10 (see FIG. 3), and a second connecting surface 22 that couples with the third foam layer 30 (see FIG. 2). FIG. 4 shows an enlarged side view of mat 1.

The first foam layer 10 has a first hardness and a first porosity. The second foam layer 20 is connected with a side of the first foam layer 10 and has a second hardness and a second porosity. The second porosity is larger than the first porosity such that the second hardness is less than the first hardness. The third foam layer 30 is connected with a side of the second foam layer 20 opposite to the first foam layer 10 and has a third hardness larger than both the first hardness and the second hardness, and a third porosity smaller than the first porosity. The second foam layer 20 includes a first connecting surface 21 facing the first foam layer 10 and a second connecting surface 22 facing the third foam layer 30, and a size of the contact area between the first connecting surface 21 and the first foam layer 10 is different from a size of the contact area between the second connecting surface 22 and the third foam layer 30. The contact areas of first connecting surface 21 and second connecting surface 22 are different because layer 30 is harder than layer 10.

The first foam layer 10 and the third foam layer 30 are selectable according to use requirements, and the second foam layer 20 provides good cushioning and shock absorption effects. Specifically, the first hardness, the second hardness and the third hardness refer to the average hardness of the first foam layer 10, the second foam layer 20 and the third foam layer 30, respectively. In one embodiment, as measured by a C type hardness tester, a value of the first hardness is within a range from 20 to 35, a value of the second hardness is within a range from 20 to 35, and a value of the third hardness is larger than 40. The C type hardness tester may be a SRIS C type hardness tester (TECLOCK, model number: GS-701N) which is mainly configured to measure an object, such as sponge, soft rubber, or other foaming bodies having a value of hardness less than SRIS A type 20. The greater the value obtained by the hardness tester, the greater the hardness of the object.

In another embodiment, the value of the first hardness is about 30, which is obtained by measuring a surface of the first foam layer 10 opposite to the second foam layer 20. The first foam layer 10 is soft and easy to be deformed, which can be used as a yoga mat for good tactility and cushioning effect. The value of the third hardness is about 50 which is obtained by measuring a surface of the third foam layer 30 opposite to the second foam layer 20. The third foam layer 30 is not easy to be deformed, which can be used to place heavy objects (such as exercise equipment, machines, or the like) for shock absorption effect and supporting stability. The value of the second hardness is about 20 which is obtained by measuring a surface of the second foam layer 20 exposed outward on a section of the mat 1. Moreover, the second foam layer 20 further includes a middle portion 23 located between the first connecting surface 21 and the second connecting surface 22, and at least one of the first connecting surface 21 and the second connecting surface 22 has a hardness larger than a hardness of the middle portion 23 so as to be tightly connected with at least one of the first foam layer 10 and the third foam layer 30.

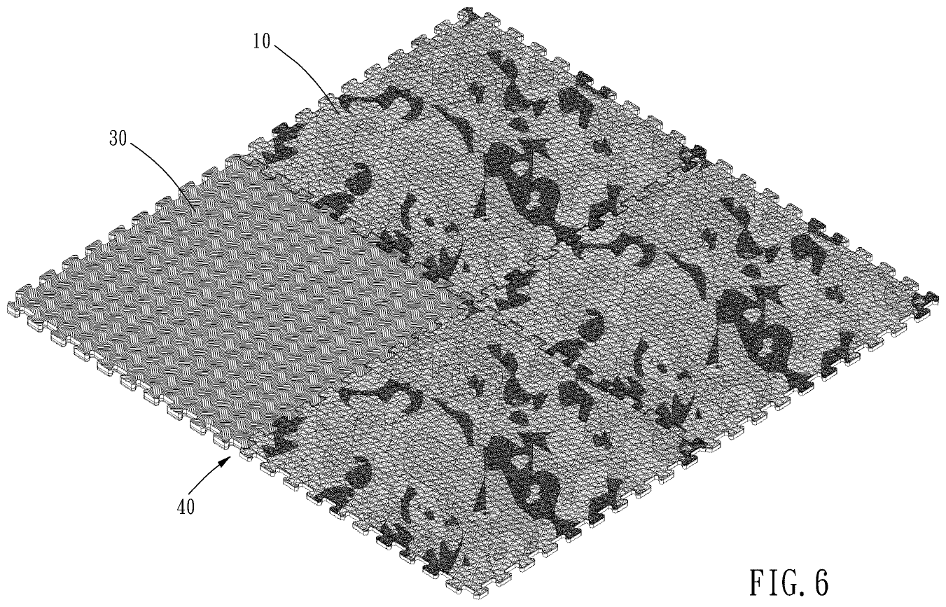

FIG. 6 shows the mat 1 having an interlocking assembling structure 40 circumferentially disposed thereon, which allows a plurality of said mats 1 to be assembled and interlocked with one another and applied to different use areas. The plurality of said mats 1 may be assembled with one another in a manner of the first foam layer 10 facing upwards or the third foam layer 30 facing upwards so as to distinguish use areas, such as a bodyweight training area and an exercise equipment area, which provides diverse arrangements and is convenient to use.

When the first foam layer 10 and the third foam layer 30 are under the same pressure during use as a floor mat, a deformed area of the first foam layer 10 is deep and narrow, and a deformed area of the third foam layer 30 is shallow and wide. FIG. 4 shows the size of the contact area between the first connecting surface 21 and the first foam layer 10 is larger than the size of the contact area between the second connecting surface 22 and the third foam layer 30 due to the different porosities of the layers and the different densities of cells within layer 20. More specifically, a density of a side of the second foam layer 20 adjacent to the first connecting surface 21 is larger than a density of a side of the second foam layer 20 adjacent to the second connecting surface 22 so that the first connecting surface 21 is tightly connected with the first foam layer 10 and is deformable corresponding to a pressed area of the first foam layer 10. The side of the second foam layer 20 adjacent to the second connecting surface 22 provides more compression space, which prevents the second connecting surface 22 and the third foam layer 30 from peeling off each other due to relative movement.

The second foam layer 20 is a closed-cell foam and includes a plurality of cells 24. The plurality of cells 24 are partially open toward the third foam layer 30 on the second connecting surface 22. The closed cells are partially opened due to heat damage during the heat welding step when second foam layer 20 and third foam layer 30 are jointed together. Heat damage does not occur on the first connecting surface 21 because first foam layer 10 and second foam layer 20 are not as hard as third foam layer 30 and therefore do not require the same heat and pressure conditions as third layer 30. The partially open cells on second connecting surface 22 improve the chemical bond with third foam layer 30. When the third foam layer 30 is pressed down during normal use, the second foam layer 20 is deformed by compression of the plurality of cells 24, which provides sufficient deformation space and prevents said layers from peeling off one another due to hardness difference. Moreover, it also avoids local depressions of the third foam layer 30 under pressure and provides good supporting effect.

A thickness of the second foam layer 20 is larger than or equal to a thickness of the first foam layer 10 and is smaller than a thickness of the third foam layer 30. Specifically, the thickness of the third foam layer 30 is at least twice the thickness of the second foam layer 20 so as to provide good supporting stability and shock absorption effect in use. The thickness of the second foam layer 20 is at least twice the thickness of the first foam layer 10 so as to have good cushioning effect. However, thicknesses of the first foam layer, the second foam layer and the third foam layer may be changed according to any requirements.

In this embodiment, the first foam layer 10 and the third foam layer 30 are made from materials including polyethylene (PE) and ethylene vinyl acetate copolymer (EVA), and a PE content of the first foam layer 10 is less than a PE content of the third foam layer 30 so that two opposite sides of the mat 1 have different hardness. EVA content of the first foam layer 10 is more than EVA content of the third foam layer 30 so that the first foam layer 10 has good anti-slip effect. The second foam layer 20 is made from materials including PE so that the hardness, thickness and elasticity of the second foam layer 20 are easy to be adjusted during manufacture. Specifically, when the third foam layer 30 faces upward and the first foam layer 10 contacts the ground, the first foam layer 10 provides better anti-slip effect when the mat 1 is pressed. For example, when an exercise equipment is placed on the third foam layer 30, the mat 1 is pressed by a weight of the exercise equipment, and a friction between the first foam layer 10 and the ground is increased so that the mat 1 is not easy to move.

Preferably, the first foam layer 10 and the third foam layer 30 are closed-cell structures, which is not easy to deform and is waterproof. A melting point of the second foam layer 20 is lower than melting points of the first foam layer 10 and the third foam layer 30. Therefore, the first connecting surface 21 and the second connecting surface 22 can be melted to be attached with the first foam layer 10 and the third foam layer 30 without any adhesive, which avoids odor and prevents structures of the first foam layer 10 and the third foam layer 30 from being damaged by heating. The first foam layer 10, the second foam layer 20 and the third foam layer 30 may further include inorganic fillers (such as calcium carbonate) so as to increase processing stability. In other embodiments, the first foam layer, the second foam layer and the third foam layer may be made from other materials, or added with dyes, plasticizers, etc.

The first foam layer 10 includes a plurality of blocks 11 embedded within one another, and the plurality of blocks 11 have at least two different colors so as to provide unique visual effect and preferable appearance (e.g., camo pattern). A surface of the first foam layer 10 opposite to the second foam layer 20 has an embossing structure 12 which provides anti-slip effect and good tactility. In other embodiments, the first foam layer may be a sheet with single color.

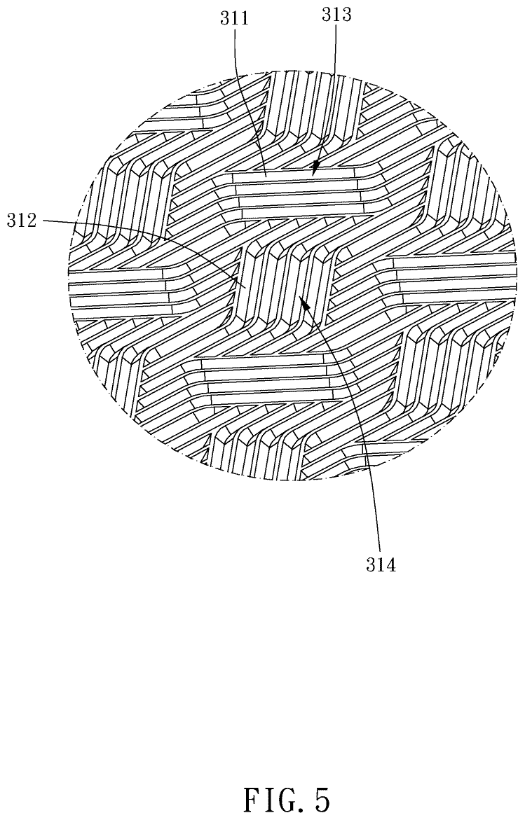

FIG. 5 shows the third foam layer 30 having a contact surface 31 opposite to the second foam layer 20, and the contact surface 31 has a plurality of first grooves 311 and a plurality of second grooves 312 extending arcuately and recessed thereon. At least a portion of the plurality of first grooves 311 extends transversely to the plurality of second grooves 312. The plurality of first grooves 311 are arranged side by side and form a plurality of first units 313, and the plurality of second grooves 312 are arranged side by side and form a plurality of second units 314. The plurality of first units 313 and the plurality of second units 314 are alternatively arranged so as to have good anti-slip effect and unique appearance. However, the plurality of first grooves and the plurality of second grooves may be configured as wavy, polygonal, geometric, etc.

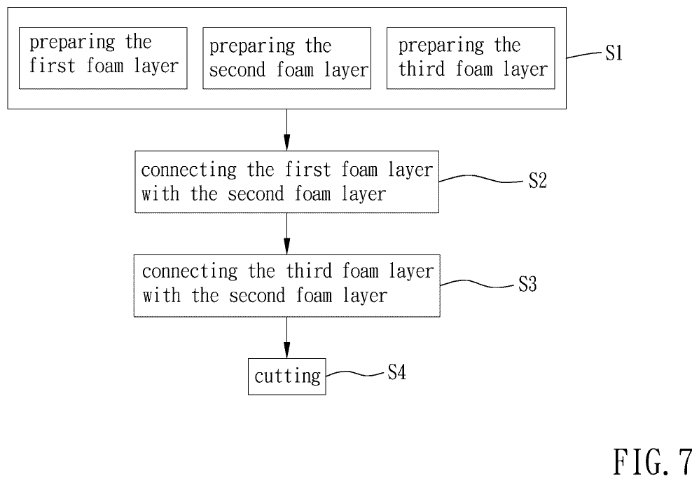

FIG. 7 further provides a method for manufacturing the mat 1 as described above, including following steps. Step S1: preparing the first foam layer 10, the second foam layer 20 and the third foam layer 30 respectively by foaming; step S2: connecting the second foam layer 20 with one of the first foam layer 10 and the third foam layer 30 by thermo-compression; step S3: connecting the second foam layer 20 with the other of the first foam layer 10 and the third foam layer 30 by thermo-compression to form a substrate; and step S4: cutting the substrate to form at least one of the mat 1.

In the step S1 of preparing the first foam layer 10, this process may further include: preparing a mold; putting a plurality of raw material particles in the mold, wherein the plurality of raw material particles have at least two different colors, and the plurality of raw material particles may include PE resin particles and EVA resin particles; melting and foaming the plurality of raw material particles to form a foaming body; and taking out the foaming body from the mold and cutting the foaming body to form at least one of the first foam layer 10 having a predetermined thickness. Therefore, a plurality of said first foam layers 10 can be obtained by single foaming process, which is convenient to manufacture. Moreover, the first foam layers 10 have a dense foam structure and is waterproof and abrasion resistant, and the plurality of blocks 11 are arranged randomly to provide unique appearance.

In this embodiment, the second foam layer 20 is made by continues foaming so that the plurality of cells 24 have large diametrical dimensions and the second foam layer 20 has a relatively loose foam structure and good compressibility. The third foam layer 30 is made by mold foaming so as to have a dense foam structure and is hard, waterproof and abrasion resistant. In processing, the second foam layer 20 is connected with the first foam layer 10 first and then is connected with the third foam layer 30. For example, in the step S2, the first foam layer 10 is aligned with the first connecting surface 21, and the first connecting surface 21 is at least partially melted by a heating mechanism (such as heat gun). Then, the first foam layer 10 and the second foam layer 20 are pressed and attached to each other by a roller mechanism. The first foam layer 10 and the second foam layer 20 are flexible and soft, which is able to be rolled after combination and is convenient to process and storage.

Similarly, in the step S3, the third foam layer 30 is aligned with the second connecting surface 22, and the second connecting surface 22 is at least partially melted by the heating mechanism. Then, the first foam layer 10 and the second foam layer 20, which are already attached together, are pressed with the third foam layer 30 and attached to each other by the roller mechanism to form the substrate. In other embodiments, the second foam layer 20 may be attached to the third foam layer 30 first and then attached to the first foam layer 10 second; the first foam layer 10 or the third foam layer 30 may be melted so as to be connected with the first connecting surface 21 or the second connecting surface 22.

Although particular embodiments of the invention have been described in detail for purposes of illustration, various modifications and enhancements may be made without departing from the spirit and scope of the invention. Accordingly, the invention is not to be limited except as by the appended claims.

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1.-15. (canceled)

16. A method of manufacturing a mat, comprising:
preparing a first foam layer, a second foam layer and a third foam layer respectively by foaming;
connecting the second foam layer with one of the first foam layer and the third foam layer by thermo-compression;
connecting the second foam layer with the other of the first foam layer and the third foam layer by thermo-compression to form a substrate; and
cutting the substrate to form at least one of the mat.

17. The method of claim 16, wherein the first foam layer has a first hardness, the second foam layer has a second hardness, and the third foam layer has a third hardness larger than both the first hardness and the second hardness.

18. The method of claim 17, wherein a value of the first hardness as measured by a C type hardness tester is within a range from 20 to 35, a value of the second hardness is within a range from 20 to 35, and a value of the third hardness is larger than 40.

19. The method of claim 16, wherein the first foam layer has a first porosity, the second foam layer has a second porosity larger than the first porosity, and the third foam layer has a third porosity smaller than the first porosity.

20. The method of claim 16, wherein a thickness of the second foam layer is larger than or equal to a thickness of the first foam layer and is smaller than a thickness of the third foam layer, and wherein the thickness of the third foam layer is at least twice the thickness of the second foam layer.

21. The method of claim 16, wherein the first foam layer and the third foam layer are made from materials including polyethylene (PE) and ethylene vinyl acetate copolymer (EVA), and a PE content of the first foam layer is less than a PE content of the third foam layer.

22. The method of claim 16, wherein a melting point of the second foam layer is lower than melting points of the first foam layer and the third foam layer so that connecting surfaces of the second foam layer can be melted to attach with the first foam layer and the third foam layer without any adhesive.

23. The method of claim 16, wherein the first foam layer and the third foam layer are closed-cell structures which are waterproof.

24. The method of claim 16, wherein the second foam layer is connected with the third foam layer first and then is connected with the first foam layer.

25. The method of claim 16, wherein connecting the second foam layer by thermo-compression includes at least partially melting a connecting surface of the second foam layer by a heat gun.

26. The method of claim 25, further comprising pressing the second foam layer with an adjacent foam layer by a roller mechanism, wherein the first foam layer and the second foam layer are flexible and soft so as to be rolled after combination for processing and storage.

27. The method of claim 16, wherein cutting the substrate includes forming an interlocking assembling structure circumferentially disposed on each of the at least one mat, which allows a plurality of the mats to be assembled and interlocked with one another and applied to different use areas.

28. A mat, comprising:
a first foam layer having a first hardness and a first porosity, wherein a surface of the first foam layer has an embossing structure providing anti-slip effect;
a second foam layer connected with a side of the first foam layer opposite to the embossing structure, the second foam layer having a second hardness and a second porosity larger than the first porosity, the second foam layer including inorganic fillers to increase processing stability; and
a third foam layer connected with a side of the second foam layer opposite to the first foam layer, the third foam layer having a third hardness larger than both the first hardness and the second hardness and a third porosity smaller than the first porosity;
wherein the first foam layer, the second foam layer, and the third foam layer are connected by thermo-compression without any adhesive;
wherein when the third foam layer faces upward and the first foam layer contacts a ground surface and an object is placed on the third foam layer, a friction between the first foam layer and the ground surface is increased so that the mat is not easy to move.

28. The mat of claim 27, wherein the inorganic fillers include calcium carbonate.

29. The mat of claim 27, wherein a thickness of the second foam layer is at least twice a thickness of the first foam layer so as to have a cushioning effect.

30. The mat of claim 27, further comprising an interlocking assembling structure circumferentially disposed thereon, which allows a plurality of the mats to be assembled and interlocked with one another.

31. A mat manufactured by thermo-compression without any adhesive, comprising:
a first foam layer including a plurality of blocks embedded within one another, wherein the plurality of blocks have at least two different colors to provide unique visual effect, and wherein the first foam layer has a first hardness value of about 30 as measured by a C type hardness tester;
a second foam layer connected with a side of the first foam layer, the second foam layer being made from materials including polyethylene (PE) so that a hardness, thickness and elasticity of the second foam layer are easy to be adjusted during manufacture, the second foam layer having a second hardness value of about 20 as measured by the C type hardness tester; and
a third foam layer connected with a side of the second foam layer opposite to the first foam layer, the third foam layer having a third hardness value of about 50 as measured by the C type hardness tester;
wherein the first foam layer is soft and easy to be deformed for use as a yoga mat for good tactility and cushioning effect, and the third foam layer is not easy to be deformed for placing heavy objects thereon for shock absorption effect and supporting stability.

32. The mat of claim 31, wherein when an exercise equipment is placed on the third foam layer, the mat is pressed by a weight of the exercise equipment, and a friction between the first foam layer and a ground surface is increased so that the mat is not easy to move.

33. The mat of claim 31, wherein the second foam layer is made by continues foaming so that a plurality of cells of the second foam layer have large diametrical dimensions and the second foam layer has a relatively loose foam structure and good compressibility.

34. The mat of claim 31, wherein the third foam layer is made by mold foaming so as to have a dense foam structure and is hard, waterproof and abrasion resistant.
